(19) United States
(12) Patent Application Publication
(10) Pub. No.: US 2004/0086425 A1
(43) Pub. Date: May 6, 2004

(54) Colorimetric analytical apparatus and use

(76) Inventor: Ivars Jaunakais, Rock Hill, SC (US)

Correspondence Address: Timothy R. Kroboth, Kroboth Law Office, 5501 Providence Country Club Drive, Charlotte, NC, 28277-2636, US

(21) Appl. No.: 10/287,659

(22) Filed: Nov. 5, 2002

(51) Int. Cl. G01N 1/22

(52) U.S. Cl. 422/86; 422/83; 436/164; 436/167; 436/181

(57) ABSTRACT

Improved calorimetric analysis technology based on the analysis of reaction gas, is disclosed. In accordance with the inventive apparatus, a gas permeable medium bearing a suitable calorimetric reagent, is positioned so that gas exiting the apparatus passes through the gas permeable medium.

### FIELD OF THE INVENTION

This invention relates to colorimetric analysis technology for gas-producing reactants.

### BACKGROUND OF THE INVENTION

Colorimetric analyses based on the analysis of a reaction gas, are known. For instance, certain commercially available tests for the analysis of arsenic utilize the reduction of arsenic to arsine gas in an acidic aqueous reaction environment, and colorimetric reaction of the arsine gas with mercuric bromide indicator. These particular tests include rapid arsenic test kits sold by Industrial Test Systems, Inc. under the marks Quick, Low-Range Quick and Ultra-Low Quick. These rapid analyses beneficially use an effective amount of a rate-increasing agent for increasing the rate of arsine gas production, and an oxidizing agent for removing interfering substances such as hydrogen sulfide. The rate-increasing agent currently is a Ni(II) salt in combination with Fe(II) salt.

These rapid arsenic test kits include a semirigid reaction vessel screw cap that is provided with a port surrounded by a raised bead, and that includes a pivotable hollow turret open from one end to the other end; and include a test strip with an indicator pad backed by a suitable plastic support. With the turret pivoted to an open position in which the hollow of the turret communicates with the cap port, the pad end of the test strip is inserted through the hollow of the turret and the cap port so that the indicator pad is within the headspace of the reaction vessel. Then, the turret is pivoted to a closed position so that the indicator pad is held in place and gaseous outflow through the cap port is blocked. U.S. patent application Ser. No. 10/045,387, filed on Nov. 9, 2001, the disclosure of which is hereby incorporated by reference, is particularly directed to rapid arsenic analysis.

Also known is a commercially available arsenic test kit that includes a soft rubber-like, flexible screw cap provided with a port and a hinged member, and a test strip with an indicator pad backed by a suitable plastic support. In use, the hinged member is positioned so that the indicator pad end of a test strip can be positioned over the port, and the pad end is positioned over the port with the pad facing the headspace of the reaction vessel. Thereafter, the hinged member is positioned to a closed position so that the indicator pad is held in place. A lower surface of the hinged member is provided with a circumferential raised bead, located to generally surround the port when the hinged member is in the closed position.

Also known is an electronic arsenic analysis instrument identified as the Arsenator 510, by which arsine gas passes from a glass reaction flask having a ground glass neck, and through a connecting glass tube into a measuring portion of the instrument. It appears from an apparently related written description entitled “The evaluation of the arsenator”, that in the measuring portion of the instrument, arsine gas passes through mercuric bromide-impregnated paper strip, and a diode emitting light and photodiode provide colorimetric analysis of the paper strip. Thereafter, the measuring portion of the instrument is opened to replace the paper strip with a fresh paper strip. Also known is a related prototype arsenic analysis instrument that uses a slidable apertured holder for impregnated paper strip.

Despite advances in calorimetric analysis technology, there remains a need for an improved analytical apparatus for gas-producing reactants.

### SUMMARY OF THE INVENTION

In accordance with the present invention, a calorimetric analytical apparatus is provided that includes a reaction vessel for gas-producing reactants, and a gas permeable medium bearing a suitable calorimetric reagent. Advantageously, the apparatus further includes a reaction vessel closure member provided with an outflow port, the closure member is a screw cap, and a test strip comprises a support from an end of which the colorimetric reagent-bearing, gas permeable carrier extends.

Beneficially, the apparatus further includes an apertured member, and during an analysis, the apparatus includes an outflow pathway that includes the outflow port and an aperture of the apertured member. Advantageously, a portion of the reagent-bearing carrier is sealingly positioned during an analysis between the outflow port and the apertured member so that gas exiting through the outflow port passes through the carrier portion. Beneficially, the carrier portion is sealingly positioned by pressure exerted upon the carrier, and the apertured member assists in the carrier portion being sealingly positioned.

In accordance with a first aspect of the invention, advantageously the apertured member is a channeled member provided with an inflow aperture and disposed during an analysis in a pressure-exerting position. Beneficially, the channeled member exerts pressure upon the carrier and the reaction vessel cap, and is locked in the pressure-exerting position.

In accordance with a second aspect of the invention, beneficially the apertured member is attached by a hinge to the apparatus and is disposed during an analysis in a pressure-exerting position. Advantageously, the apertured member exerts pressure upon the carrier and the reaction vessel closure member, and is attached by the hinge to the reaction vessel closure member.

In accordance with the invention, the reagent-bearing carrier is beneficially releasably positioned in the outflow pathway, and may be released by applying a suitable force to the apertured member.

Using the inventive apparatus in an analysis of particular interest, arsenic is reduced to arsine gas in an acidic aqueous reaction environment, beneficially in the presence of an effective amount of a rate-increasing agent for increasing the rate of arsine gas production, and arsine gas is removed from the gaseous outflow stream by reaction with a suitable calorimetric indicator for arsine gas. Thereafter, the indicator-bearing carrier portion is conveniently evaluated by color matching.

Additional advantages and beneficial features of the present invention are set forth in the drawing and detailed description, and in part will become apparent to those skilled in the art upon examination of the drawing and detailed description or may be learned by practice of the invention. In the drawing and detailed description, there are shown and essentially described only preferred embodiments of this invention, simply by way of illustration of the best mode contemplated of carrying out this invention. As will be realized, this invention is capable of other and different embodiments, and its several details are capable of modification in various respects, all without departing from the invention. Accordingly, the drawing and the detailed description are to be regarded as illustrative in nature, and not as restrictive.

### BRIEF DESCRIPTION OF THE DRAWING

Reference is now made to the accompanying drawing, which forms a part of the specification of the present invention and illustrates preferred embodiments of the present invention.

FIG. 1 is a partial cross-sectional view of a colorimetric analytical apparatus in accordance with the present invention, illustrating a calorimetric reagent-bearing carrier sealingly positioned so that outflow gas exiting the apparatus passes through a portion of the carrier;

FIG. 2 is an exploded view, in partial cross-section, of the apparatus of FIG. 1, without the test strip;

FIG. 3 is a perspective view of the screw cap of FIG. 1 without the channeled turret;

FIG. 4 is, as indicated by line 4-4 of FIG. 3, a top view of the screw cap of FIG. 3;

FIG. 5 is a partial cross-sectional view of the FIG. 3 cap, taken substantially along line 5-5 of FIG. 4;

FIG. 6 is a perspective view of a portion of the channeled turret of the apparatus of FIG. 1;

FIG. 7 is a cross-sectional view taken substantially along line 7-7 of FIG. 6;

FIG. 8 is a cross-sectional view taken substantially along line 8-8 of FIG. 2;

FIG. 9 illustrates in perspective view the test strip used in FIG. 1, including the calorimetrically developed portion of the carrier;

FIG. 10 is a cross-sectional view similar to that of FIG. 1, of a second preferred embodiment of a calorimetric analytical apparatus in accordance with the present invention, illustrating the pivotably mounted channeled turret thereof in a pressure-exerting position for sealingly positioning a colorimetric indicator-bearing carrier in the outflow pathway;

FIG. 11 is a cross-sectional view similar to that of FIG. 10, illustrating the pivotably mounted channeled turret in a test strip releasing position;

FIG. 12 is an exploded perspective view, showing further details of the screw cap and pivotable channeled turret of the apparatus of, FIG. 10;

FIG. 13 is a cross-sectional view like that of FIG. 10, of a third preferred embodiment of a colorimetric apparatus in accordance with the present invention, taken substantially along line 13-13 of FIG. 14; and

FIG. 14 is a perspective view showing further details of the cap and hinged cap member of FIG. 13, with the hinged cap member in a test strip releasing position.

### DETAILED DESCRIPTION OF THE INVENTION

The present invention is directed to an improved analytical apparatus for gas-producing reactants that is convenient to use and has a quick set-up. The inventive apparatus is self-contained and portable, and beneficially can provide increased sensitivity and uniformity of color development. The apparatus is particularly useful for the analysis of arsenic, and especially useful for low levels of arsenic in the range of 0.5 ppb to about 10 ppb, up to about 60 ppb or more, as well as for yet lower levels of arsenic in the range of 0.1 ppb to about 10 ppb, up to 40 ppb or more. The inventive apparatus can advantageously provide reproducibility of results for low levels of arsenic or other analytes without the use of electronics or batteries. As will be understood, terms such as upper, lower, top, above, upwardly, down, vertical, horizontal and the like are relative, and have been particularly used with reference to the drawing to assist understanding.

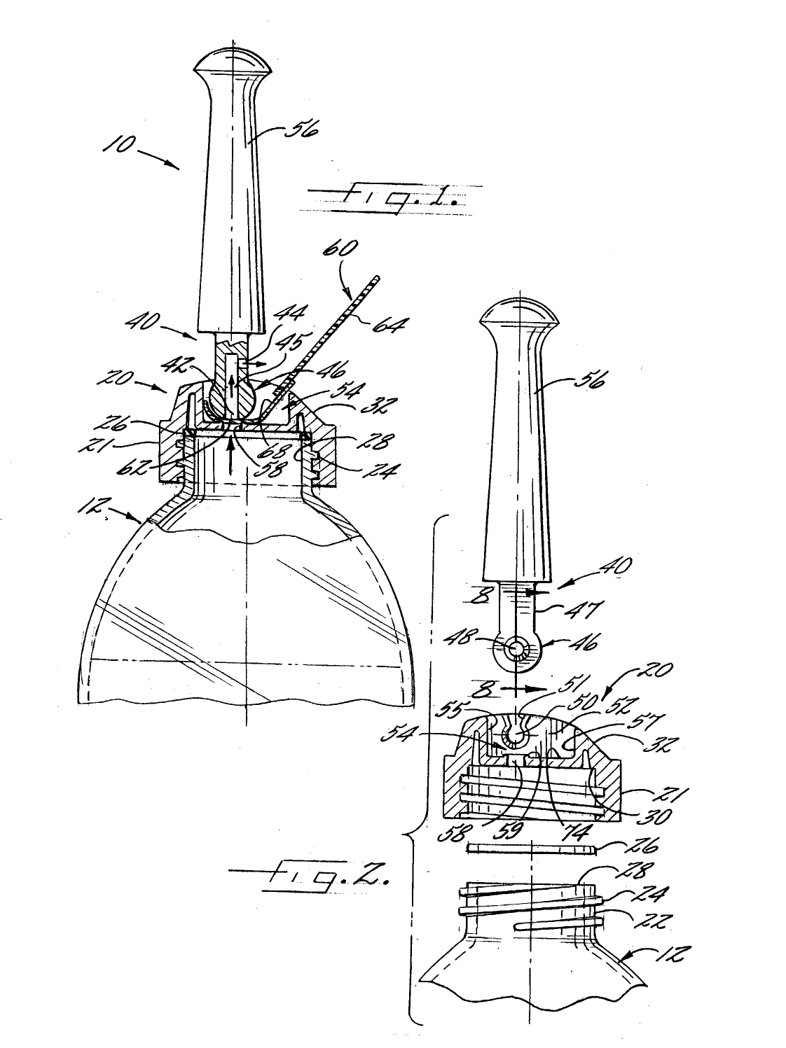

In accordance a first embodiment of the present invention and referring to FIG. 1, a preferred calorimetric analytical apparatus 10 is provided. The apparatus includes a suitable reaction vessel 12 for reaction of gas-producing reactants. Beneficially, the reaction vessel is provided with a volume-indicating line (not shown) for indicating an appropriate volume (indicated in phantom line) of a sample to be analyzed. Although the sample volume can vary, a beneficial volume for analysis of a low level of arsenic will typically be in the range of about 250 to 1000 ml, for example, 250 or 600 ml. However, smaller sample volumes, for example, a 50 ml volume or less, can be used, with benefit.

If needed, a sample may be diluted to the desired volume. A sample may also be diluted to provide a suitable analyte concentration for analysis. Furthermore, the low level sensitivity of the inventive technology allows dilution when an interfering substance is in excess of the allowable limit for the interference substance. In such case, a sample can be diluted to bring the interfering substance within the allowable limit, and yet the inventive apparatus remains sensitive to the diluted analyte concentration. In all such cases, the dilution factor is taken into account to determine the analyte concentration in an undiluted sample.

Conveniently, reaction vessel 12 is made of a transparent, semirigid plastic material. As indicated in FIG. 1, a generally cylindrical shape may be used for the reaction vessel.

With reference also to FIG. 2, apparatus 10 advantageously further includes a removable cap 20 for the reaction vessel, with a screw cap having an interiorly threaded side wall 21 being convenient. To cooperate with the cap threads, an upper portion 22 of the reaction vessel is provided with external screw threads 24. Beneficially, cap 20 is made of a semirigid plastic material. By comparison, as will be further explained, a soft rubber-like material such as is used in a previously described, prior art screw cap, is generally not suitable for a cap useful in the present invention.

When cap 20 is in place, an O-ring 26 may be used to prevent any reaction gas from escaping between a mouth 28 of the reaction vessel and the cap. To this end and referring particularly to FIG. 2, O-ring 26 may be suitably seated between mouth 28 and an inner circumferential surface 30 of a top wall 32 of the cap. A snap cap can be used instead of the screw cap.

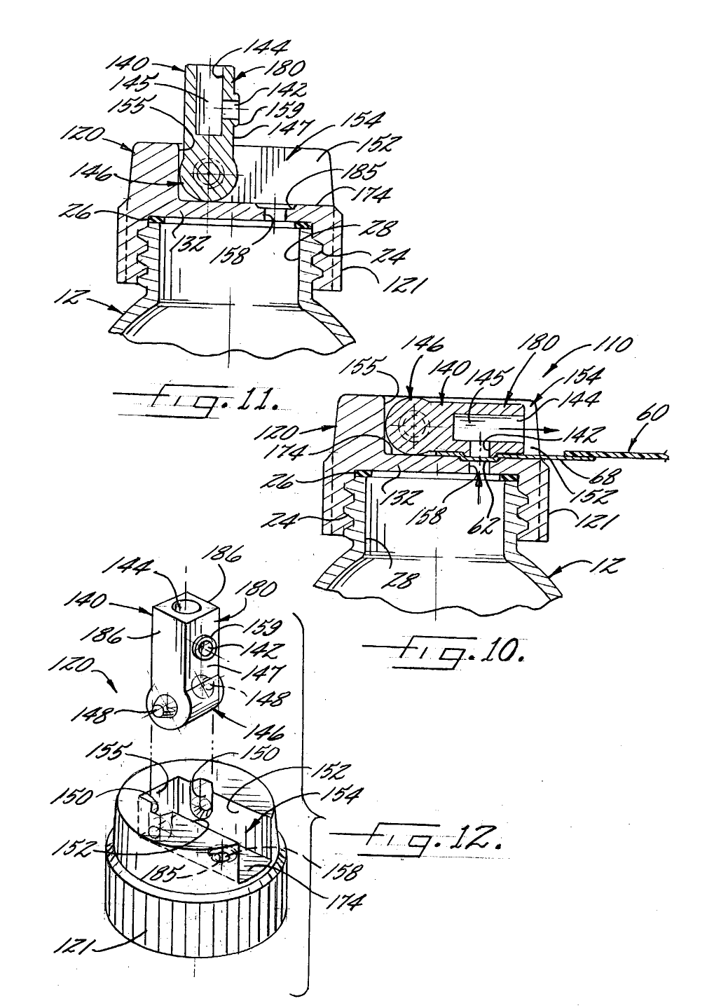

Referring particularly to FIG. 1, but for details also to FIGS. 2 to 8, advantageously cap 20 includes a channeled turret 40 provided with an inflow aperture 42 and a communicating outflow aperture 44 connected by a channel 45. As indicated in FIGS. 7 and 8, channel 45 may be substantially dimensionally consistent with the inflow aperture and substantially dimensionally constant from the inflow aperture to the outflow aperture. Conveniently, the inflow aperture is located at a turret end 46, and the outflow aperture is located in a turret side wall 47. Turret inflow end 46 conveniently is generally rounded and includes a pair of oppositely extending bosses 48 of appropriate size and shape for mating with opposing cavities 50 in the cap. When the turret is attached to the cap, conveniently bosses 48 are disposed in mating cavities 50 in a snug friction fit, and the corresponding turret end is beneficially positioned for exerting pressure on a test strip.

With reference to the details of FIGS. 2 to 5, for seating bosses 48 in generally frustoconically shaped cavities 50, opposing generally v-shaped side channels 51 lead to cavities 50. Conveniently, cavities 50 and seating channels 51 are located in opposing side walls 52 of a recess 54 in top wall 32 of the cap. As a skilled artisan will readily recognize, other ways can be used to attach a suitable gaseous outflow member to the cap, and furthermore, if desired, pivotability of channeled turret 40 can be prevented.

Referring to FIGS. 1 and 2 again, conveniently disposed opposite the turret inflow end is a grippable end 56 of the turret. Grippable end 56 benefits removal of removably connected end 46 of the turret from attachment to the cap, as well as re-connection of the turret end to the cap. An appropriately located rear wall 55 of recess 54 assists generally vertical orientation of the channeled turret during re-connection of turret end 46. Conveniently, recess 54 is further defined by a wall 57 located opposite to wall 55.

Beneficially, with reference to FIGS. 1 to 5, cap 20 is provided with an outflow port 58. Conveniently, as best seen in FIGS. 2 to 5, outflow port 58 is generally centrally disposed in top wall 32 and leads to recess 54 into which a raised bead 59 disposed around the outflow port extends.

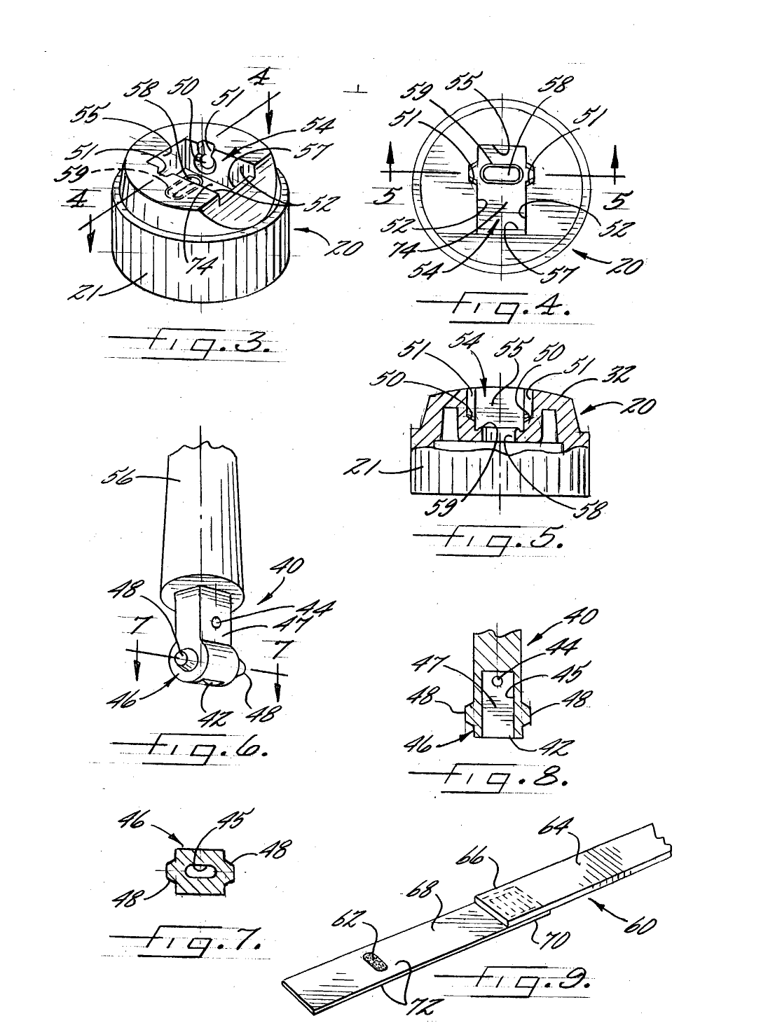

Advantageously, with particular reference to FIGS. 4, 6 and 7, the outflow port of the cap and inflow aperture 42 of the channeled turret are of like size and shape, and present a similar cross-sectional area perpendicular to an initial outflow direction described later. However, as will become understood, the similar size, shape and cross-sectional area are not necessary features of the invention.

During an analysis, it is beneficial for the channeled turret and cap to be connected, and outflow port 58 and inflow aperture 42 to be generally aligned and in fluid communication. As can be understood, apparatus 10 advantageously provides an outflow pathway for passage of gas from the reaction vessel and into the channeled turret, and then from the apparatus through an outflow aperture. It will be readily appreciated that the outflow pathway requires only a portion of aperture 42 to be aligned with, and in fluid communication with, outflow port 58. As will become clear from the details that follow, reproducible and accurate analysis as herein described, is benefitted by outflow gas being channeled through an indicator-impregnated, gas permeable medium, and the analytical apparatus being free of any other outflow pathway.

As may be observed from FIGS. 4 and 6 in particular, the outflow pathway of an inventive apparatus may include an aperture of significantly less cross-sectional flow area than the outflow port. Thus, during an analysis, cap 20 of apparatus 10 is provided not only with the outflow port but also with communicating outflow aperture 44 of relatively smaller flow size. When smaller, the flow size of the relatively smaller aperture is nevertheless sufficient to benefit flow through the gas permeable medium and out of the apparatus such that the apparatus retains inventive advantage. Connecting channel 45 could be of like reduced flow size at its outflow end.

The initial outflow direction is defined by an arrow located in reaction vessel 12 of FIG. 1. Also shown in FIG. 1 is an arrow exiting outflow aperture 44 of the turret, from which it may be understood that the direction of outflow may conveniently change to a direction generally perpendicular to the initial outflow direction. As a result, the outflow direction at the exit from the apparatus, may, as illustrated, be generally perpendicular to the longitudinal axis (indicated in phantom line) of the turret.

With reference to FIG. 9, a test strip 60 conveniently includes a support 64 from an end 66 of which an indicator-bearing, gas permeable medium 68 extends. Beneficially in the case of mercuric bromide indicator and the like, support 64 protects a user from contact with impregnated medium 68.

In accordance with the present invention, calorimetric indicator-bearing, gas permeable carrier 68 is located with respect to an outflow pathway, so that outflow gas exiting the apparatus passes through the carrier. Advantageously, a portion of carrier 68 of test strip 60 is interposed in the outflow pathway, and in particular between the outflow port of the cap and an aperture through which outflow gas exits the apparatus. Conveniently, the aperture is in direct fluid communication with the ambient atmosphere. Illustrative are FIGS. 1, 10, 13, which show a portion 62 of carrier 68 sealingly interposed in an outflow pathway.

It has been found that when the outflow gas passes through a relatively smaller cross-sectional area of the gas permeable medium, the color change will be more concentrated than when the cross-sectional area is relatively larger. Thus, there is benefit in the cross-sectional area through which the outflow gas passes, being of limited size. A balancing consideration is that the cross-sectional area should be of appropriate large enough size to aid accurate color determination, and in particular color matching using an unaided eye.

The portion of the test strip indicated in FIG. 9 by line 62, illustrates the calorimetrically developed portion of carrier 68 obtained using apparatus 10 of FIG. 1. As thus indicated in FIG. 9, the carrier is advantageously provided with a sufficient width so that in the applications shown in FIGS. 1, 10 and 13, the outflow port is covered by the carrier and outflow gas passes through the carrier.

Conventional adhesive or any other conventional technique may be conveniently used to affix an end 70 of carrier 68 and end 66 of support 64 to one another. As shown in FIG. 9, carrier 68 is otherwise free of support by support 64, thereby providing for flow through opposing faces 72 of carrier 68, the opposing faces having a relatively greater width than the sides of the carrier.

Support 64 may suitably be the same semirigid plastic support, and carrier 68 may suitably be the same filter paper, used as a test strip support and pad for the previously described, rapid arsenic test kits. However, any suitable gas permeable medium may be used. Suitable gas permeable filter papers may illustratively have a thickness in range of from about 0.1 to 0.6 mm, a basis weight in the range of from about 30 to 100 g/m², a water absorbency in the range of from about 0.9 to 2.9 g/100 cm², and liquid filtration speed per ASTM E832-81 of from less than 1 second to about 50 seconds. It should, however, be understood that the foregoing characteristics are intended as a guide, and therefore are not, generally speaking, limiting. For sake of further illustration, a highly suitable gas permeable filtration paper may have a thickness of about 0.2 mm, a basis weight of about 90 g/m², a water absorbency of about 1.3 g/100 cm², and liquid filtration speed of about 30 seconds.

A suitable calorimetric indicator for arsine gas is mercuric bromide, although any other suitable indicator for arsine gas or other analyses, may be used. In the arsenic analysis of particular interest, a suitable indicator reacts with, and removes, arsine gas from the gas stream, which also may include hydrogen gas, as the gas stream passes through the gas permeable medium.

As may be understood, it is beneficial for the portion of the gas permeable medium positioned in the outflow pathway, to be generally uniformly loaded with calorimetric reagent, and for the loading thereof to stoichiometrically exceed the moles of gas to be reacted with. A useful loading will vary depending upon the sample volume and the analyte concentration, and from time to time, sample dilution will be appropriate to reduce the analyte concentration, depending upon the sensitivity of the analytical test. When a suitable gas permeable medium is impregnated or saturated with, for example, mercuric bromide indicator using conventional techniques, the medium is generally uniformly loaded with the indicator, and a sufficient loading of indicator is obtained. A typical loading of a calorimetric indicator may be in the range of from about 0.1 to 1 mg/in², but, as indicated, a greater loading or less loading may be sufficient.

Accordingly, it may be understood that it is preferred that escape of any toxic gas from the inventive apparatus is prevented. In this respect, a sample may be first analyzed using a less sensitive test to confirm that the more sensitive test provided by the inventive technology, is appropriate. In addition, there may be occasions, as mentioned, when a sample should be diluted in preparation for use of the inventive technology. Also, other precautions such as choosing a well-ventilated area or chemical hood, may be taken.

To carry out an analysis using apparatus 10, channeled turret 40 is conveniently detached from cap 20 by exertion of a suitable pulling force on grip end 56 of the turret. Then, carrier 68 of the test strip is positioned over the outflow port, it being recognized that the carrier is beneficially provided with a sufficient width as indicated in FIG. 9 and previously described. As indicated in FIG. 1, the free end of the carrier may extend past the outflow port and into contact with recess wall 55 (also see FIG. 2). Thereafter, bosses 48 of end 46 of the channeled turret are pushed into V-shaped channels 51 and pressed into snap fit engagement with cap slots 50. As a result, end 46 of the turret is locked into a pressure-exerting position, and the portion of the carrier positioned beneath the turret end and over the outflow port is beneficially pressed by mechanical pressure exerted upon the carrier into sealing contact with the outflow port of the cap. In apparatus 10, this pressure is exerted upon the carrier by the turret end and raised bead 59, which extends upwardly from a recess surface 74. Furthermore, when inflow aperture 42 of the turret end is beneficially arranged so that during an analysis it is (as shown in FIG. 1) generally aligned with the outflow port, portion 62 of the carrier is in sealing contact also with the inflow aperture. Contact of recess wall 55 with the facing wall of the channeled turret may conveniently assist in this arrangement.

As may thus be understood, reaction vessel cap 20, as well as later described caps 120, 220, are advantageously sufficiently rigid that indicator-impregnated medium 68 is sealingly positioned in the outflow pathway by mechanical pressure exerted upon the impregnated medium. Thus, in the case of apparatus 10 for instance, turret end 46 and raised bead 59 in particular are of appropriate rigidity. Accordingly, a compressible, rubber-like material such as is used in a previously described, prior art screw cap for the raised bead of a positionable hinged member and around the cap port, is generally not suitable for sealingly positioning an indicator-impregnated medium in an outflow pathway by the application of mechanical pressure to the medium.

As will be readily appreciated by one skilled in the art, the structure shown for apparatus 10 may be modified in suitable ways to exert mechanical pressure to sealingly position the indicator-impregnated medium in the outflow pathway. In any event, as a result of the impregnated medium being sealingly positioned in the outflow pathway of an inventive apparatus, gas exiting through the outflow port beneficially passes through portion 62 of medium 68 and does not otherwise escape. Thereafter, referring again to the embodiment of FIG. 1, gas not removed from the gaseous stream by reaction with the calorimetric indicator in carrier 68, passes via inflow aperture 42 into the channeled turret, and exits apparatus 10 through outflow aperture 44.

After an appropriate period of time, portion 62 of carrier 68 is released from being sealingly positioned in the outflow pathway, by exertion of a suitable gripping force on grip end 56 of the turret. As a result, the turret may, as illustrated in FIG. 2, be detached. However, as one skilled in the art can readily understand, release of portion 62 from the sealing contact may be accomplished other than by disconnecting the turret from the cap. For example, in a modified structure, turret end 46 could be repositioned by sliding or otherwise moving bosses 48 or the like from a first position corresponding to the pressure-exerting position described for apparatus 10, to a non-pressure-exerting position spaced apart from the first position and spaced away from the outflow port, yet in connection with cap 20. Thus, it may be understood that the structure shown for apparatus 10, may be modified in suitable ways that provide for release of the carrier from the outflow pathway.

After release of the indicator-impregnated medium from the outflow pathway, beneficially, a distinct depression (not shown in FIG. 9) defined by bead 59, is found in the medium and the color is found to be within the depression. The exertion of mechanical pressure upon the medium and compression of the medium advantageously result in the outflow gas passing through carrier portion 62 and prevent lateral leakage within the medium from carrier portion 62. If color is found outside carrier portion 62, the test should usually be repeated.

The color of portion 62 is conveniently visually evaluated, typically by comparison with an appropriate standardized color chart. The color may, of course, also be determined instrumentally. A color chart may be beneficially provided with a plurality of apertures each generally centered in the respective color patch, through which the color may be viewed for color matching.

The gas entry face of the gas permeable medium can be expected to show greater color change than the gas exit face, indicating removal by the calorimetric reagent of relatively more gas from the incoming gas stream than from the gas stream as it exits the gas permeable medium. In some cases, a gas exit face shows no color change. In any event, the color is advantageously uniform on the gas entry face, for the cross-sectional area through which the outflow gas passes.

Generally, it will be best to carry out the color comparison within about 30 seconds after the gas permeable medium has been released from being positioned in the outflow pathway, because after about 30 seconds, the color may begin to change. It will typically be best to color match in daylight, but direct sunlight should be avoided.

Referring now to FIGS. 10-12, a second preferred embodiment of the present invention is illustrated. Apparatus 110 differs from apparatus 10 in that a different removable cap 120 is used with reaction vessel 12 and reagent-impregnated, gas permeable carrier 68. For sake of brevity, the same numbering is used for reaction vessel 12 and test strip 60 of apparatus 110, as was used for apparatus 10. In addition, corresponding 100 series numbering has been used with respect to cap 120 for like parts. It is thus intended that reference can be made to the earlier description relative to apparatus 10.

As before, cap 120 is conveniently a screw cap. However, differences include the lack of recess wall 57 of cap 20. As a result, the test strip and in particular reagent-impregnated, gas permeable carrier 68, may, as shown in FIG. 10, advantageously be generally planar along its length when positioned over an outflow port 158 in a top wall 132 of cap 120. A resulting benefit is that when calorimetrically developed portion 62 of carrier 68, is released from being sealingly positioned, the carrier is substantially planar or flat for color matching as illustrated in FIG. 9.

Further differences relative to cap 20 are that a channeled turret 140 of cap 120 lacks grippable end 56 of turret 40, is generally rectangular, and is provided with an outflow aperture 144 at a turret end 180. Moreover, turret 140 is provided with an inflow aperture 142 in a turret side wall 147, instead of in a turret end 146. Thus, in the case of cap 120, gaseous outflow not removed by the colorimetric reagent, enters the channeled turret through a side wall and exits through an end of the turret; whereas, in the case of cap 20, the gaseous outflow enters the channeled turret through a turret end and exits through a side wall of the turret. As illustrated in FIG. 10, the outflow direction at the exit from the inventive apparatus, may be generally parallel to the longitudinal axis of the turret.

Conveniently, with continued reference to FIG. 10, cap outflow port 158 and turret inflow aperture 142 may be of like generally circular size and shape. However, a generally elliptical shape (used in cap 20) or other suitable shape may be used if desired.

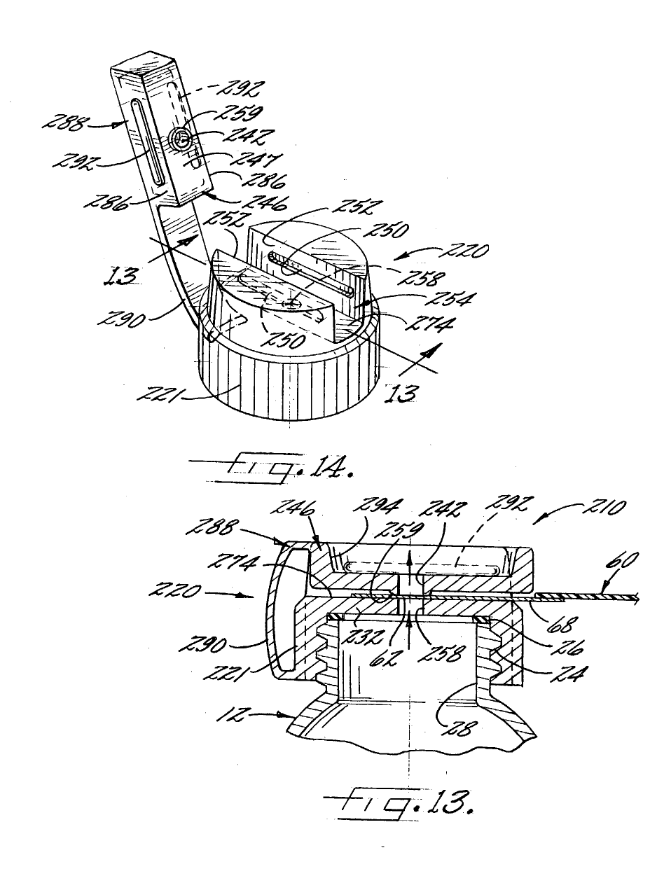

Referring now to FIGS. 11 and 12 in particular, to assist in the indicator-impregnated carrier being sealingly interposed in the outflow pathway, conveniently a generally circumferential bead 159 extends from turret side wall 147 around inflow aperture 142, and an upper surface 174 of cap top wall 132 may be provided with a mating recess 185. When the channeled turret is positioned as shown in FIG. 10, the portion of the carrier positioned beneath raised bead 159 and over outflow port 158 is beneficially pressed by mechanical pressure exerted upon the carrier into sealing contact with the outflow port and the inflow aperture. In the case of apparatus 110, this pressure is exerted by raised bead 159 being seated in recess 185. As will be readily appreciated by one skilled in the art, mechanical pressure can be exerted in other ways to sealingly position the carrier in the outflow pathway. For example, in place of raised bead 159, a pressure-exerting, gas permeable pad could be attached to turret side wall 147 around the inflow aperture. In any event, as before, the outflow port is conveniently located in cap top wall 132 so as to be generally aligned with, and in fluid communication with, the turret inflow aperture during an analysis.

To limit outflow from the turret to turret end 180, a channel 145 of the channeled turret may, as best seen in FIGS. 10 and 11, conveniently be closed off at generally opposite turret end 146 by turret structure. However, blockage of outflow through that turret end if that turret end were not closed by turret structure, could also be accomplished by blocking contact of a recess end wall 155 against that turret end, during an analysis. If desired, gaseous outflow could be allowed to exit both turret ends.

In the case of apparatus 10, although channeled turret 40 thereof may, as shown by the drawing, be pivotably mounted to cap 20, there is no need to make use of the pivotability in carrying out an analysis, However, pivotability of pivotably mounted, channeled turret 140 benefits use of apparatus 110.

Referring to FIG. 12 in particular, conveniently turret end 146 is generally rounded and includes bosses 148, and bosses 148 are pivotably disposed in mating cavities 150 located in opposing side walls 152 of a cap recess 154. Side walls 186 of the turret are conveniently of an appropriate size and shape to snugly friction fit against opposing recess side walls 152. In this way, the pressure-exerting position of raised bead 159 of channeled turret 140 is maintained.

To carry out an analysis, the turret is pivoted conveniently to a generally vertical position as illustrated in FIG. 11. Then, the free end of reagent-impregnated carrier 68 of the test strip is inserted between opposing recess walls 152, and positioned over the cap outflow port. Thereafter, the turret is pivoted to a generally horizontal position as illustrated in FIG. 10, and that causes pressure-exerting bead 159 to exert pressure against carrier 68 and recess 185 in upper surface 174 of cap wall 132, and beneficially results in portion 62 of the carrier being sealingly interposed in the outflow pathway. By comparison, in the case of apparatus 10, turret 40 is disposed in a generally vertical pressure-exerting position during an analysis. After an appropriate period of time, portion 62 of the carrier is released from being sealingly positioned in the outflow pathway, by pivoting the turret from the generally horizontal position.

Referring now to FIGS. 13 and 14, a third preferred embodiment of the present invention is illustrated. Apparatus 210 differs from apparatus 10 in that a different removable cap 220 is used with reaction vessel 12 and reagent-impregnated, gas permeable carrier 68. For sake of brevity, the same numbering is used for reaction vessel 12 and test strip 60 of apparatus 210, as was used for apparatus 10. In addition, corresponding 200 series numbering has been used with respect to cap 220 for like parts of caps 10, 110. It is thus intended that reference can be made to the earlier description relative to apparatus 10, 110.

As before, cap 220 is conveniently a screw cap. However, referring to FIG. 14 in particular, differences include the lack of opposing recess walls 55, 57 of cap 20, as a result of which a cap recess 254 conveniently extends completely across an upper surface 274 of a top wall 232 of the cap. Further differences relative to cap 20 are use of a generally rectangular, hinged cap member 288 in place of channeled turret 40, and that cap member 288 is conveniently connected to a cap side wall 221 by a hinge 290 when not positioned for an analysis.

Conveniently, cap member 288 includes side walls 286 provided with elongated raised beads 292 that are of an appropriate size and shape to snap fit into mating recesses 250 of opposing recess walls 252 of cap 220. Conveniently, side walls 286 of cap member 288 and recess walls 252 are, as shown in FIG. 14, generally planar; however, other suitable shapes may be used. For example, cap member 288 may have a generally cylindrical peripheral wall, and the mating recess may have a generally cylindrical wall.

Similar to turret 140, a lower wall 247 of cap member 288 is provided with an aperture 242. Conveniently, with reference now to FIG. 13 in particular, a cap outflow port 258 and aperture 242 may be of like generally circular size and shape. However, a generally elliptical shape (used in cap 20) or other suitable shape may be used if desired.

Conveniently and with reference again to FIG. 14 in particular, to assist in the indicator-impregnated carrier being sealingly interposed in the outflow pathway, a generally circumferential bead 259 extends from lower wall 247 of apertured cap member 288, around aperture 242 of the cap member, for pressing against upper surface 274 of cap top wall 232. When elongated beads 292 of the apertured cap member are snap fit into place as indicated in FIG. 13, portion 62 of the carrier positioned beneath circumferential bead 259 and over outflow port 258 is beneficially mechanically pressured into sealing contact with the outflow port and aperture 242.

As before, outflow port 258 is conveniently located in cap top wall 232 so as to be generally aligned with, and in fluid communication with, aperture 242 during an analysis. Aperture 242 leads to an upper recess 294 in apertured cap member 288. As a result of calorimetric reagent-impregnated medium 68 being sealingly positioned in the outflow pathway of apparatus 220, gas exiting through outflow port 258 beneficially passes through portion 62 of medium 68 and does not otherwise escape. Thereafter, gaseous outflow not removed from the gaseous stream by reaction with the calorimetric indicator in carrier 68, exits the apparatus through aperture 242 and communicating recess 294 of apertured cap member 288. As indicated in FIG. 13, there may be no change in the outflow direction from when gaseous outflow passes through the outflow port to its exit from an inventive apparatus.

To carry out an analysis using cap 220, elongated beads 292 of apertured cap member 288 are disengaged from recesses 250, and the cap member pivots away from cap wall 232 to a position as illustrated in FIG. 14. Then, the free end of reagent-impregnated carrier 68 of the test strip is inserted between opposing recess walls 252, and positioned over the cap outflow port. Thereafter, the apertured cap member is pivoted to, and locked into, a generally horizontal position as illustrated in FIG. 13, and that causes pressure-exerting circumferential bead 259 of the apertured cap member to exert pressure against carrier 68 and upper surface 274 of the cap, and beneficially results in portion 62 of the carrier being sealingly interposed in the outflow pathway. After an appropriate period of time, portion 62 of the carrier is released from being positioned in the outflow pathway, by disengaging elongated beads 292 from mating recesses 250.

In the below Examples, a 1000 ppb arsenic stock solution of arsenic trioxide in dilute acid, is used to prepare samples containing arsenic. Other than the samples that contain no arsenic, these samples are prepared using the stock solution and arsenic-free water to give an aqueous solution having the specified concentration of arsenic. All samples are free of hydrogen sulfide. In these Examples and throughout this description, all parts and percentages are weight percent unless otherwise specified.

### ULTRALOWII EXAMPLES

600 ml of arsenic-free water having a temperature of about 25° C., is added to plastic reaction bottle 12 having a volumetric capacity of about 850 ml. Thereafter, a powder containing L-tartaric acid (15 g), iron(II)sulfate.7H₂O (36 ppm Fe⁺²), and nickel(II)sulfate.6H₂O (34 ppm Ni⁺²) is added to the sample, and the reaction bottle is capped using a conventional cap and shaken vigorously for 15 seconds. Thereafter, 2.6 g of Oxone® powder is added (this step could have been omitted due to the lack of interfering substance in the sample), and the capped reaction bottle is shaken vigorously for 15 seconds, and then allowed to stand undisturbed for 2 minutes. Oxone® includes potassium peroxymonosulfate and potassium peroxydisulfate as oxidizing agents.

During this 2 minute period of time, cap 20 of inventive apparatus 10 is prepared for use as follows. Channeled turret 40 is detached from cap 20, and a portion of mercuric bromide-impregnated carrier 68 prepared by a conventional technique, is positioned over outflow port 58 of cap 20. Thereafter, end 46 of the channeled turret is pressed into snap fit engagement with mating cavities 50 of the cap, with outflow port 58 and inflow aperture 42 of the channeled turret being generally aligned. As a result, referring to FIG. 1, portion 62 of the carrier is pressed into sealing contact with the outflow port and the inflow aperture of the turret.

Thereafter, 7.2 g of zinc powder is added to the reaction bottle and the capped reaction bottle is shaken vigorously for 5 seconds, after which the conventional cap is replaced by cap 20 prepared as previously described.

After 10 minutes at room temperature in a well-ventilated area where inventive apparatus 10 will not be disturbed, portion 62 of carrier 68 is released from the sealing contact with the channeled turret and the outflow port of cap 20, by detaching the turret from cap 20. Thereafter within the next 30 seconds, the color of portion 62 of down face 72 of the carrier is color matched. The result is set forth in Table 1 under the column headed Yellow (ULII).

Thereafter, the foregoing procedure is repeated using samples containing 0.1, 0.2, 0.5, 1, 2, 3, 4, 5 and 6 ppb As. The color of portion 62 is observed to be uniform on the down face of the carrier. The results are set forth in Table 1 under the column headed Yellow (ULII). A relatively higher Yellow value indicates a relatively darker Yellow color, and a relatively higher concentration of analyte in the sample. Increasing the Ni⁺² level, for instance, to about 100 ppm, further benefits the intensity of color development within the 10 minute reaction period.

### ULTRALOW EXAMPLES

600 ml of arsenic-free water having a temperature of about 25° C., is added to a plastic reaction bottle 12 having a volumetric capacity of about 850 ml. Thereafter, a powder containing L-tartaric acid (15 g), iron(II)sulfate.7H₂O (36 ppm Fe+²), and nickel(II)sulfate.6H₂O (34 ppm Ni+²) is added to the sample, and the reaction bottle is capped using a conventional cap and shaken vigorously for 15 seconds. Thereafter, 2.6 g of Oxone® powder is added, and the capped reaction bottle is shaken vigorously for 15 seconds, and then allowed to stand undisturbed for 2 minutes.

Thereafter, 7.2 g of zinc powder is added to the reaction bottle and the capped reaction bottle is shaken vigorously for 5 seconds, after which the conventional cap is replaced by a cap provided with a port and a pivotable hollow turret open from one end to the other end. With the hollow turret in the open position, a test strip with a mercuric bromide-impregnated indicator pad backed by a plastic support is inserted through the hollow of the turret and the cap port until a red line on the test strip is even with the top of the turret, and then the turret is pivoted to the closed position. As a result, the indicator pad is positioned in the headspace of the reaction bottle and gaseous outflow through the turret is blocked.

After 10 minutes at room temperature in a well-ventilated area where the reaction apparatus will not be disturbed, the turret is pivoted to the open position, and the test strip is withdrawn. Thereafter within the next 30 seconds, the pad color is color matched. The result is set forth in Table 1 under the column headed Yellow (UL).

Thereafter, the foregoing procedure is repeated using samples containing 0.5, 1, 2, 3, 4, 5 and 6 ppb As. The pads are observed to be darker at the edges than center. The results are set forth in Table 1 under the column headed Yellow (UL).

### LOW RANGE II EXAMPLES

250 ml of arsenic-free water having a temperature of about 25° C., is added to plastic reaction bottle 12 having a volumetric capacity of about 360 ml. Thereafter, a powder containing L-tartaric acid (7.5 g), iron(II)sulfate.7H₂O (43 ppm Fe⁺²), and nickel(II)sulfate.6H₂O (41 ppm Ni⁺²) is added to the sample, and the reaction bottle is capped using a conventional cap and shaken vigorously for 15 seconds.

Thereafter, 1.3 g of Oxone® powder is added (this step could have been omitted due to the lack of interfering substance in the sample), and the capped reaction bottle is shaken vigorously for 15 seconds, and then allowed to stand undisturbed for 2 minutes. During this 2 minute period of time, cap 20 of inventive apparatus 10 is prepared for use as described for the UltralowII Examples.

Thereafter, 3.6 g of zinc powder is added to the reaction bottle and the capped reaction bottle is shaken vigorously for 5 seconds, after which the conventional cap is replaced by cap 20 with portion 62 of carrier 68 sealingly positioned and outflow port 58 and inflow aperture 42 generally aligned.

After 10 minutes at room temperature in a well-ventilated area where inventive apparatus 10 will not be disturbed, portion 62 of the carrier is released from the sealing contact with the channeled turret and the outflow port of cap 20, by detaching the turret from cap 20. Thereafter within the next 30 seconds, the color of portion 62 of down face 72 of the carrier is color matched. The result is set forth in Table 2 under the column headed Yellow (LRII).

Thereafter, the foregoing procedure is repeated using samples containing 0.5, 1, 2, 4, 6, 8 and 10 ppb As. The color of portion 62 is observed to be uniform on the down face of the carrier. The results are set forth in Table 2 under the column headed Yellow (LRII). Increasing the Ni⁺² level, for instance, to about 100 ppm, further benefits the intensity of color development within the 10 minute reaction period.

### LOW RANGE EXAMPLES

250 ml of arsenic-free water having a temperature of about 25° C., is added to a plastic reaction bottle 12 having a volumetric capacity of about 360 ml. Thereafter, a powder containing L-tartaric acid (7.5 g), iron(II)sulfate.7H₂O (43 ppm Fe⁺²), and nickel(II)sulfate.6H₂O (41 ppm Ni⁺²) is added to the sample, and the reaction bottle is capped using a conventional cap and shaken vigorously for 15 seconds. Thereafter, 1.3 g of Oxone® powder is added, and the capped reaction bottle is shaken vigorously for 15 seconds, and then allowed to stand undisturbed for 2 minutes.

Thereafter, 3.6 g of zinc powder is added to the reaction bottle and the capped reaction bottle is shaken vigorously for 5 seconds, after which the conventional cap is replaced by the turreted bottle cap used in the UltraLow Examples. With the hollow turret in the open position, a test strip with a mercuric bromide-impregnated indicator pad backed by a plastic support is inserted through the hollow of the turret and the cap port until a red line on the test strip is even with the top of the turret, and then the turret is pivoted to the closed position. As a result, the indicator pad is positioned in the headspace of the reaction bottle and gaseous outflow through the turret is blocked.

After 10 minutes at room temperature in a well-ventilated area where the reaction bottle will not be disturbed, the turret is pivoted to the open position, and the test strip is withdrawn. Thereafter within the next 30 seconds, the pad color is color matched. The result is set forth in Table 2 under the column headed Yellow (LR).

Thereafter, the foregoing procedure is repeated using samples containing 2, 4, 6, 8 and 10 ppb As. The pads are observed to be darker at the edges than center. The results are set forth in Table 2 under the column headed Yellow (LR).

The present invention may be carried out with various modifications without departing from the spirit or essential attributes thereof, and accordingly, reference should be made to the appended claims, rather than to the foregoing specification as indicating the scope of the invention.

TABLE 1

| As (ppb) | Yellow (ULII) | Yellow (UL) |
|---|---|---|
| 0 | 2 | 0 |
| 0.1 | 9 | N/A |
| 0.2 | 12 | N/A |
| 0.5 | 18 | 4 |
| 1 | 26 | 7 |
| 2 | 34 | 11 |
| 3 | 42 | 16 |
| 4 | 47.5 | 20 |
| 5 | 52 | 24 |
| 6 | 55 | 28 |

TABLE 2

| As (ppb) | Yellow (LRII) | Yellow (LR) |
|---|---|---|
| 0 | 2 | 2 |
| 0.5 | 9 | N/A |
| 1 | 15 | N/A |
| 2 | 23 | 8 |
| 4 | 40 | 11 |
| 6 | 52 | 13 |
| 8 | 55 | 18 |
| 10 | 57 | 22 |

1. A calorimetric analytical apparatus comprising
a reaction vessel for gas-producing reactants,
a reaction vessel closure member provided with an outflow port,
an apertured member, and
a gas permeable carrier bearing a suitable calorimetric reagent,
wherein during an analysis,
said apparatus comprises an outflow pathway comprising said outflow port and an aperture of said apertured member, and
a portion of said carrier is sealingly positioned in said outflow pathway between said outflow port and said apertured member, by mechanical pressure exerted upon said carrier so that gas exiting through said outflow port and thereafter through said apertured member, passes through said portion of said carrier.

2. The apparatus of claim 1, wherein the sealingly positioned portion of said carrier is in sealing contact with said outflow port.

3. The apparatus of claim 2, wherein said sealingly positioned portion of said carrier is also in sealing contact with said apertured member.

4. The apparatus of claim 1, wherein said apertured member assists in said carrier portion being sealingly positioned, and said carrier portion is releasably sealingly positioned.

5. The apparatus of claim 1, wherein a raised bead disposed around said outflow port and that extends toward said carrier, assists in said carrier portion being sealingly positioned.

6. The apparatus of claim 1, wherein a raised bead disposed around said aperture of said apertured member and that extends toward said carrier, assists in said carrier portion being sealingly positioned.

7. The apparatus of claim 1, wherein said apertured member is a channeled member provided with an inflow aperture and a communicating outflow aperture.

8. The apparatus of claim 7, wherein said carrier portion is sealingly positioned by said channeled member being disposed in a pressure-exerting position against said reaction vessel closure member.

9. The apparatus of claim 8, wherein said reaction vessel closure member is a cap, and said channeled member is attached to said cap and locked in said pressure-exerting position.

10. The apparatus of claim 1, wherein said apertured member is attached by a hinge to said reaction vessel closure member.

11. The apparatus of claim 1, wherein said aperture is in direct fluid communication with the ambient atmosphere and provides for exit of the outflow gas from said analytical apparatus.

12. The apparatus of claim 1, wherein a test strip comprises a support from an end of which an end of said carrier extends.

13. A calorimetric analytical apparatus comprising
a reaction vessel for gas-producing reactants,
a reaction vessel cap provided with an outflow port,
a channeled member provided with an inflow aperture, and
a gas permeable carrier bearing a suitable colorimetric reagent,
wherein during an analysis,
said apparatus comprises an outflow pathway comprising said outflow port and said inflow aperture, and
a portion of said carrier is sealingly positioned in said outflow pathway between said outflow port and said inflow aperture, by mechanical pressure exerted upon said carrier so that gas exiting through said outflow port and into said channeled member via said inflow aperture, passes through said portion of said carrier.

14. The apparatus of claim 13, wherein said channeled member assists in said carrier portion being sealingly positioned, and said carrier portion is releasably sealingly positioned.

15. The apparatus of claim 14, wherein said channeled member is attached to said cap, and disposed in a pressure-exerting position against said cap.

16. A calorimetric analytical apparatus comprising
a reaction vessel for gas-producing reactants, said reaction vessel being provided with an outflow port,
an apertured member attached by a hinge to said apparatus, and
a gas permeable carrier bearing a suitable calorimetric reagent,
wherein during an analysis,
said apparatus comprises an outflow pathway comprising said outflow port and an aperture of said apertured member, and
a portion of said carrier is sealingly positioned in said outflow pathway between said outflow port and said apertured member, by mechanical pressure exerted upon said carrier so that gas exiting through said outflow port and thereafter through said aperture of said apertured member, passes through said portion of said carrier, and
said apertured member assists in said portion of said carrier being sealingly positioned.

17. The apparatus of claim 16, further comprising a reaction vessel cap provided with said outflow port, wherein said apertured member is attached to said cap and disposed in a pressure-exerting position against said cap.

18. The apparatus of claim 17, wherein said carrier portion is releasably sealingly positioned.
